(19) United States
(12) Patent Application Publication
(10) Pub. No.: US 2016/0242596 A1
(43) Pub. Date: Aug. 25, 2016

(54) Reservior Filling System

(71) Applicant: Mark Andrew Bennett, Jacksonville, FL (US)

(72) Inventor: Mark Andrew Bennett, Jacksonville, FL (US)

(21) Appl. No.: 15/054,052

(22) Filed: Feb. 25, 2016

Related U.S. Application Data
(60) Provisional application No. 62/120,845, filed on Feb. 25, 2015.

(51) Int. Cl. A47J 31/54

(52) U.S. Cl. CPC A47J 31/54

(57) ABSTRACT

An apparatus for adapting the reservoir of a counter top beverage maker to a water line, comprises a mounting plate for engaging an outer wall of a reservoir, a connector extending from an inside wall of the reservoir, through the reservoir wall, and connecting to the mounting plate, a valve retained on the mounting plate, and a fluid passageway for communicating fluid from the outlet of the valve, through the connector, and into the reservoir. The valve includes an inlet, an outlet, and a fluid passageway allowing for the control of water into the reservoir.

This application claims the benefit of U.S. provisional application No. 62/120,845, filed on Feb. 25, 2015, which is incorporated herein by reference for all purposes.

### FIELD OF INVENTION

The present invention relates generally to beverage maker systems, and more specifically to a reservoir filling system, for filling a reservoir of a countertop beverage maker.

### BACKGROUND

The majority of conventional coffee and tea makers purchased by consumers for use at home typically have a water reservoir that must be filled manually, for example, by a consumer transferring water from the sink to the counter top beverage maker reservoir using a pitcher, glass, or cup. This process can prove inconvenient and cost inefficient time to the consumer.

### SUMMARY

In one illustrative embodiment, an apparatus for adapting the reservoir of a counter top beverage maker to a water line, comprises a mounting plate for engaging an outer wall of a reservoir, a connector extending from an inside wall of the reservoir, through the reservoir wall, and connecting to the mounting plate, a valve retained on the mounting plate, and a fluid passageway for communicating fluid from the outlet of the valve, through the connector, and into the reservoir. The valve includes an inlet, an outlet, and a fluid passageway allowing for the control of water into the reservoir.

The features and function can be achieved independently in various embodiments of the present disclosure or may be combined into a hot beverage brewing system comprising the apparatus for adapting the reservoir of a counter top beverage maker, a heating system, and a water reservoir.

### DESCRIPTION OF THE DRAWINGS

FIG. 1 is a side view the reservoir filling system;

FIG. 2 is a side view of the reservoir filling system installed on a water reservoir of a representative example of a countertop, consumer device that heats water for food or beverage preparation; and

FIG. 3 is a flowchart of the processes for installing and operating the reservoir filling.

The system and method of use of the present invention is capable of various adaptations, modifications, and alternative forms. The specific embodiments presented in the drawings and described in detail are representative examples. It should be understood that the particular embodiments described should not be construed to limit the invention.

### DETAILED DESCRIPTION OF EMBODIMENT

Illustrative preferred and other embodiments of the present invention and method of use are provided below, including the structure and method of use. Illustrative embodiments are intended to be examples, and not to limit the invention to the precise form described. The illustrative embodiments are being used to explain the basic elements and function of the invention, as well as provide adequate teachings to enable others skilled in the art to follow, with the understanding that the invention is not limited to the particular form and details of the illustration and embodied unless expressly limited by the claims.

The various features of the illustrated embodiments are examples of a method and means for adapting to a conventional countertop coffee or tea maker having a water reservoir that must be refilled manually to allow it to be connected to a water line. Such countertop devices do not have a structure that allows direct connections to a water line for filling the reservoir. The method and means described below allow for reservoir filling with fewer tools and in less time. In addition, once installed, a reservoir filling system increases efficiency and convenience associated with making, for example, hot beverages.

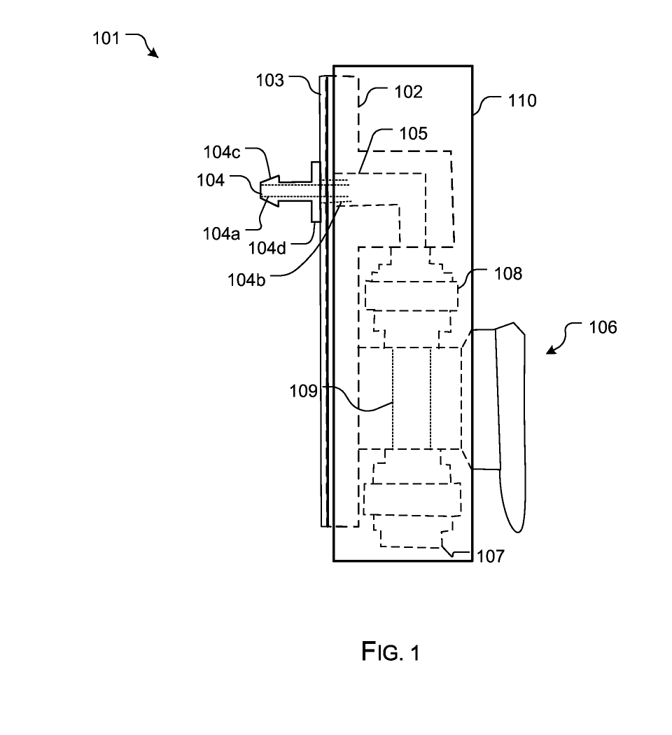

Referring now to the drawings, wherein like reference characters identify corresponding or similar elements, FIG. 1 depicts a side view of a reservoir filling system in accordance with an illustrative embodiment of the present invention. In the provided illustrative example, system 101 includes a mounting plate 102 in communication with a connector 104 that, in this example, extends from one side of the mounting plate—the side of the mounting plate for facing an outer wall of a reservoir of a countertop device for heating water—in a direction that is generally normal (at an angle that is within 45 degrees of the normal) or preferably normal, to the plane of side of the mounting plate from which it extends.

In this example, the mounting plate 102 has disposed on it a layer 103 of material. The layer 103 of material can comprise an adhesive backing, a foam pad, a rubber pad, or any other like layer for retaining or improving retention of the mounting plate 102 to an outside surface of a reservoir wall, including by either providing mounting place to the wall, or preventing shifting or rotation of the mounting plate. In addition, the mounting plate 102 has a portion, though which is formed a fluid passageway 105 in communication with a valve 106 and connector 104. Connector 104 has defined through its body a fluid passageway 104a. In this example, connector 104 has a threaded end 104b, a barb 104c on an opposite, free end, and a collar or flange 104d between the two ends that extends radially outwardly from an outer circumference of the connector's body. In this example, the collar is integrally formed with the body of the connector. The threaded end of the connector is screwed into a complementary threaded opening in the mounting plate to secure the connector to the mounting plate while, at the same time, establishing a fluid passageway between the connector and mounting plate. The valve includes an fluid inlet 107, an outlet 108, and an inner fluid passageway 109. Alternatively, fluid passageway 105 may be formed by tubing or a separate structure that is attached to the mounting plate. FIG. 1. further illustrates an example of an optional decorative cover 110 for placement over the mounting plate 102 and the valve 106. This example allows for the valve to be operated while improving the aesthetic appearance of system 101.

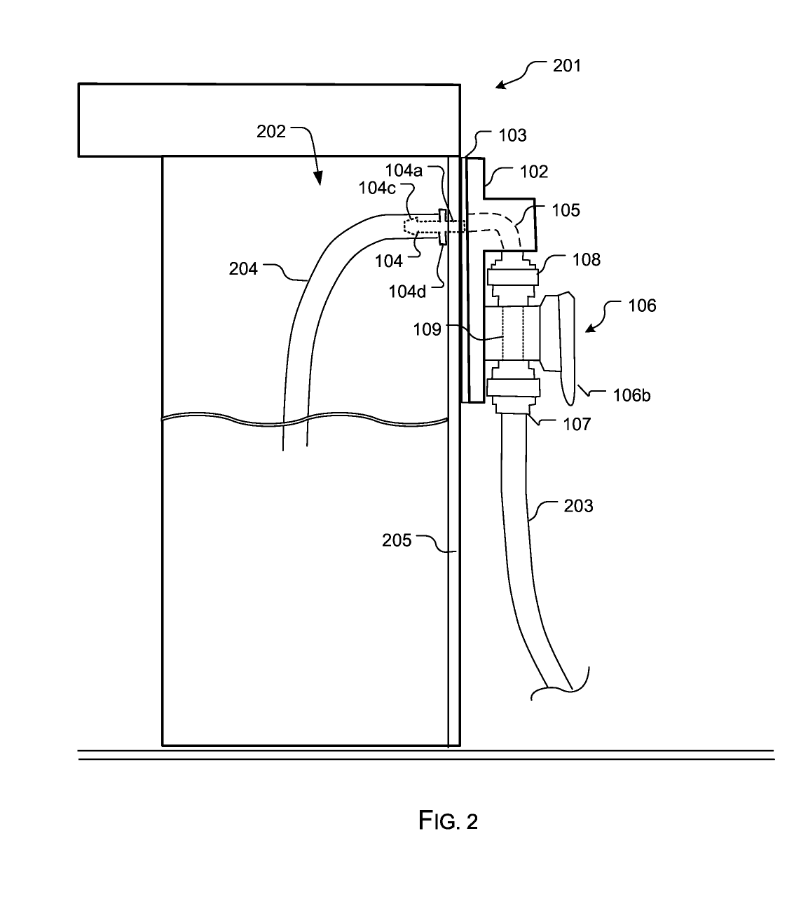

FIG. 2 is a side view of system 101, without a cover, retrofitted to a countertop device 201, which is this example is a hot beverage maker, such as for making coffee, and mounted onto an outer surface of an outside wall of a reservoir 202 of that device. In the illustrative embodiment, the mounting plate 102 is placed against an outside or exterior surface of outside wall 205 that defines, at least in part, water reservoir 202. The threaded end 104b of connector 104 is inserted through an opening formed in the wall 205, such as be drilling, and screwed into the threaded opening on the side of mounting plate 102 that is placed against the exterior surface of the wall. The collar 104d cooperates with the inside surface of wall 205 to secure system 101 to the device 201. Layer 103 may also be used—either instead of, or in addition to, the collar 104d—to secure the mounting plate to the wall using an adhesive material.

In an example of an alternative embodiment, the collar of the connector could be formed by a nut or similar flange-like structure, having threaded opening, screwed onto the body of the connector from the inside of reservoir rather permanently formed on the body of the connector 104. For purposes of this specification, “collar” includes nuts and other flange-like structures extending radially form the body of the connector, whether or not removable or integrally formed, unless the context plainly indicates otherwise. Threads would be formed on the body of the connector. The connector could, if desired, be attached to the mounting plate prior to inserting it through the opening. In this example, the mounting plate is placed against the wall of the reservoir, with the connector extending through the opening in the wall of the reservoir, and the nut then screwed onto the body of the connector to help secure the system 101 to the wall 205 of the reservoir of the device 201. With this embodiment, rather than attaching the connector to the mounting plate by a threaded connection, the connector could, optionally, be attached to the mounting plate by, for example, pressing fitting, welding, or brazing, the connector to the mounting plate, or otherwise in a manner that does not otherwise permit disconnection and reconnection of the connector from the mounting plate during normal or intended installation or uninstallation of the system 101. In other embodiments, other means for securing the system 101 to the device could also be used in place of, or in addition to, collar 104d or a layer 103 made of adhesive material.

In the illustrated example, the layer 103 is optional and may not be required, but it may improve the security with which the mounting plate 102 is attached to the wall of the reservoir 202.

A water line 203 tied into an existing line, such as one supplying a consumer's refrigerator or sink, is connected to the inlet 107 of the valve 106 using, for example, a compression fitting. Further, a filling tube 204 is attached to the connector 104. The filling tube redirects the flow of water downward. In the illustrated example, the barbed end 104c of the connector allows for easy connection of a short length of plastic tubing to act as the filling tube 204 by pushing the tubing over the barbed end.

Valve 106 selectively blocks and opens an internal passageway 109 to the flow of water between inlet 107 and 108 and an outlet. In this example valve 106 has a handle 106b for manually opening and closing the valve. Examples of valves 106 include, but are not limited to, simple ball valves or butterfly valves made of plastic, metal, or any other appropriate material. Further, it should be appreciated that the connector 104 can vary in form and material, including pipe or tubing made of plastic, metal, or other appropriate material, and threaded so as to securely connect to the mounting plate 102 through the wall of the reservoir 202. It is contemplated that a combination of elements allowing for both the securement of the mounting plate 102 to the wall of the reservoir 202 and the flow of water from the mounting plate 102 into the reservoir 202 can replace the connector 104.

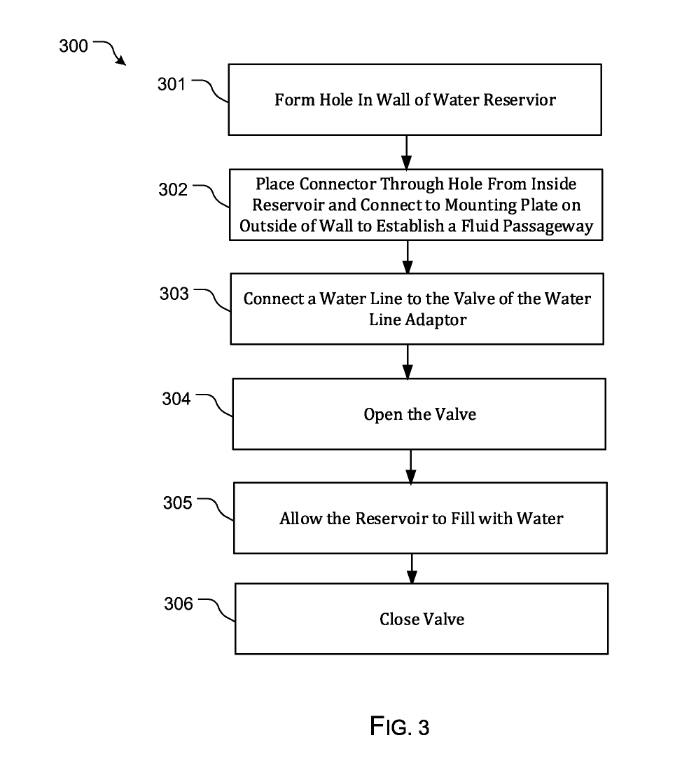

FIG. 3 depicts an example of the process of using the present invention. During use, a consumer follows a set of directions to form a hole in the reservoir 202 of the beverage maker 201 and attach the mounting plate 102 to the wall of the reservoir 202, as shown with boxes 301 and 302. The consumer then secures a water line originating, to example, from the consumer refrigerator or sink to the inlet 107 of the valve 106, as shown with box 303. A consumer may access a water line 203 on their own or may enlist the services of a plumber to access and adapt the water line to the inlet 107 of the valve 106. The consumer is able then to fill the reservoir 202 by opening the valve 106, allowing the reservoir 202 to fill with water, and subsequently to close the valve 106, as shown with boxes 304, 305, and 306.

As can be seen by the foregoing example, system 101 may be easily incorporated into the use of a counter top beverage maker to adapt it for connection to a water line. This incorporation reduces the risk of spillage associated with conventionally transfer water from a sink to a conventional beverage maker and increases the efficiency and convenience of making hot beverages.

Additional embodiments of the present application contemplate that system 101 may, without departing from the scope of the appended claims, vary in size and materials as aesthetical, functional, or manufacturing considerations require. In addition, it should be appreciated that the present invention may further comprise a mounting plate and valve cover for further aesthetic appeal. In an alternative embodiment, for example, floating valve shut off mechanism may be placed inside the beverage maker reservoir and connected, allowing for automatic shut off at a desired level of water.

The particular embodiments disclosed are intended to be illustrative only, as embodiments may be modified and practiced in different but equivalent manners.

What is claimed is:

1. An apparatus for adapting a counter top device for heating water, with a manually refillable reservoir, for connection to a water line, comprising:
a mounting plate having a first side adapted for engaging an outer wall of a reservoir, and a second side opposite the first side;
a valve disposed on the second side of the mounting plate, the valve comprising an inlet for connection to a water source and an outlet;
a connector extending from the first side of the mounting plate, in a direction generally normal to the first side of the mounting plate, and having a fluid passageway extending from a first end of the connector, nearest the mounting plate, and a free end of the connector, the fluid passageway in fluid communication with the outlet of the valve.

2. The apparatus of claim 1, wherein the connector has a collar formed on a body portion of the connector, between the first end and the free end of the connector.

3. The apparatus of claim 2, wherein the collar is integrally formed with the connector.

4. The apparatus of claim 3 wherein the connector has a threaded end for removably connecting to a threaded opening formed in the mounting plate, the threaded opening being in fluid communication with the outlet of the valve.

5. The apparatus of claim 2, wherein the collar is screwed onto on threads formed on an outside surface of the body portion.

7. The apparatus of claim 5, wherein the first end of the connector is permanently affixed to the mounting plate.

8. The apparatus of claim comprising a flexible, reservoir filling tube connected to the free end of the connector.

9. The apparatus of claim 1, further comprising a decorative cover for placement around the mounting plate and the valve.

10. A hot beverage brewing system comprising:
a water reservoir, the water reservoir having at least one outside wall with an exterior surface;
a heating system for heating water from the reservoir; and
a water line adapting apparatus comprising:
a mounting plate having a first side engaging the exterior surface of the outer wall of the reservoir, and a second side opposite the first side;
a valve disposed on the second side of the mounting plate, the valve comprising an inlet for connection to a water source and an outlet;
a connector extending from the first side of the mounting plate, through a hole in the outside wall of the reservoir, generally in a direction normal to the first side of the mounting plate, and having a fluid passageway extending from a first end of the connector next to the mounting plate, a free end extending into the reservoir, and a fluid passageway formed through the connector in fluid communication with the outlet of the valve.

11. The apparatus of claim 10, wherein the connector has a collar formed on a body portion of the connector, between the first end and the free end of the connector.

12. The apparatus of claim 11, wherein the collar is integrally formed with the connector and cannot be removed.

13. The apparatus of claim 12 wherein the connector has a threaded end for removably connecting to a threaded opening formed in the mounting plate, the threaded opening being in fluid communication with the outlet of the valve.

14. The apparatus of claim 13, wherein the collar is screwed onto on threads formed on an outside surface of the body portion.

15. The apparatus of claim 5, wherein the first end of the connector is permanently affixed to the mounting plate.

16. The apparatus of claim comprising a flexible, reservoir filling tube connected to the free end of the connector.

17. A method for adapting a countertop hot beverage brewing system, having a manually refillable water reservoir, for refilling by a water line, the method comprising:
installing a water line adapting apparatus onto an outside wall of the water reservoir of a countertop hot beverage brewing system, installing comprising,
forming a hole in the outside wall;
inserting an elongated connector through the hole;
placing a mounting plate having a first side against an exterior surface of the outside wall of the reservoir, wherein the mounting plate has disposed on a second side opposite the first side, a valve comprising an inlet for connection to a water source and an outlet;
securing the mounting plate to the outside wall;
wherein the connector extends from the mounting generally in a direction normal to the first side of the mounting plate, and has a fluid passageway extending from a first end of the connector next to the mounting plate, a free end extending into the reservoir, and a fluid passageway in fluid communication with the outlet of the valve, the fluid passageway formed along the central axis of the connector;
connecting a water line to the inlet of the valve; and
opening the valve allowing water to flow into the water reservoir of the countertop hot beverage brewing system.

18. The method of claim 17, further comprising, closing the valve manually to shut off water flow.

19. The method of claim 17, further comprising, deactivating water flow when a water level in the reservoir reaches a pre-set level.

20. The method of claim 17, wherein securing the mounting plate to the outside wall comprises placing a radially extending collar disposed on a body portion of the connector adjacent to an inside surface of the outside wall, whereby the mounting plate and collar cooperate to retain the mounting plate against the outside wall.
